(19) United States
(12) Patent Application Publication
(10) Pub. No.: US 2009/0137147 A1
(43) Pub. Date: May 28, 2009

(54) Electric connector module

(75) Inventors: Chien Chun Yang, Taoyuan (TW); Jing Heng Lin, Taoyuan (TW)

Correspondence Address: JACKSON WALKER, L.L.P., 112 E. PECAN, SUITE 2400, SAN ANTONIO, TX, 78205, US

(73) Assignee: P-Two Industries Inc.

(21) Appl. No.: 12/082,849

(22) Filed: Apr. 15, 2008

(30) Foreign Application Priority Data
Nov. 28, 2007 (TW) 096145087

(51) Int. Cl. H01R 12/24

(52) U.S. Cl. 439/499

(57) ABSTRACT

An electric connector module is disclosed. The electric connector module comprises a circuit board, an electric connector and a flexible flat cable. The electric connector is soldered to the circuit board which has a plurality of board terminal points. The electric connector has a pressing member and a positioning housing which has a body and lateral positioning arms located on each side of the body for forming a positioning space therebetween to accommodate the flexible flat cable. The pressing member is rotatably mounted between positioning arms by a rotating device. The pinch points are arranged evenly on the pressing member and their location are corresponding to the board terminal points. The pinch points are pressed onto the flexible cable for making the wire terminal points contact with the board terminal points tightly when the pressing member is placed in a closed position.

### FIELD OF THE INVENTION

The invention relates to an electric connector module, and more particularly to an electric connector module having a simplified and low height structure and capable of more smooth electrical transmission.

### BACKGROUND OF THE INVENTION

Generally, the flexible flat cable is a product of wrapping the inducting wires, i.e. the signal wires, by using the plastic insulated layers. The characteristic of the flexible flat cable is flexible, light weight and thin. Therefore, the flexible flat cable is suitable to be used for the tool boxes having limited spaces, such as the notebook computer, the cellular phone, the printer, the hard disk driver and the CD-ROM driver. While in use, the flexible flat cable does not connect to the circuit board directly but via an electric connector mounted thereon, such an electric connector is commonly referred to as a flexible flat cable connector.

In prior arts, the U.S. Pat. No. 6,099,346 discloses a flexible flat cable connector having a rectangular insulated body, a movable rotating cover and several block terminals. Each block terminal has a parallel upper arm and a lower arm and is embedded in the rectangular insulated body. The rectangular insulated body has a positioning space for accommodating the flexible flat cable. The upper arms are used to connect the movable rotating cover for enabling the movable rotating cover to rotate on the insulated body, and the lower arms are used to connect the flexible flat cable for forming the electrical connection between the lower arms and contact points of the flexible flat cable. The soldered portions of the block terminals are stretched out from the insulated body and soldered to the circuit board for transmitting the signals. While in use, the flexible flat cable is inserted into the positioning space, and the movable rotating cover is pressed onto the flexible flat cable for forming an electric connection between block terminals and contact points of the flexible flat cable so as to transmit the signal.

The above-mentioned flexible flat cable connector needs the block terminals to connect the flexible flat cable and the circuit board, in order to achieve the purpose of electric connection. However, the most block terminals have higher height because of having upper arms and lower arms parallel to each other, this leads to a higher height of insulated body in order to accommodate such block terminals, thereupon the height of electric connector can not be further reduced for other applications. Furthermore, due to the number of the block terminals is enormous and the size is small, it is not easy to discover the defects of several block terminals which may cause the connection between the connector and the flexible flat cable to fail. Therefore, such block terminals do not only impact the yield and assembly rate, but also increase the labor cost.

In view of the drawbacks of the prior art, the inventor of the present invention based on years of experience in the related industry to conduct extensive researches and experiments, and finally developed an electric connector module without block terminals to overcome the aforementioned drawbacks.

### SUMMARY OF THE INVENTION

One objective of the present invention is to provide an electric connector module which makes the flexible flat cable electrically connect to the circuit board without using the block terminals.

Another objective of the present invention is to provide an electric connector module. The structure of the electric connector module is flatter and simpler than the prior art implementations.

Another objective of the present invention is to provide an electric connector module which enables the flexible flat cable to engage on the circuit board by pressing the pinch points of the pressing member directly onto the recessed part of the flexible flat cable, so as to make the electrical transmission smooth and stable.

Another objective of the present invention is to provide an electric connector module without block terminals, to simplify the assembly process as well as to reduce assembly man hour.

The other objective of the present invention is to provide an electric connector module. By embedding the blockage part of the positioning arm into the recessed groove of the flexible flat cable, the electric connector module can prevent the flexible flat cable from slipping off the circuit board.

The present invention discloses an electric connector module comprising a circuit board, an electric connector and a flexible flat cable. The electric connector is soldered to the circuit board which has a plurality of board terminal points. The electric connector comprises a positioning housing and a pressing member. The positioning housing has a body and lateral positioning arms located on each side of the body. The body and the lateral positioning arms define a positioning space therebetween for accommodating the flexible cable. The pressing member is rotatably mounted between positioning arms by a rotating device. The rotating device enables the pressing member to rotate. The pressing member has pinch points corresponding to the board terminal points. The pinch points are pressed onto the flexible cable when the pressing member is placed in a closed position, so that the wire terminal points can contact with the board terminal points tightly, and the pressing member can prevent the flexible flat cable from being slipped out.

### BRIEF DESCRIPTION OF THE DRAWINGS

The subject matter regarded as the invention is particularly pointed out and distinctly claimed in the concluding portion of the specification. The invention together with features and advantages thereof may best be understood by reference to the following detailed description with the accompanying drawings in which:

FIG. 1 illustrates an exploded view of the electric connector in one embodiment of the present invention.

FIG. 2 illustrates another exploded view of the electric connector in one embodiment of the present invention.

FIG. 3 illustrates an exploded view of the electric connector and the module in one embodiment of the present invention.

FIG. 4 illustrates a cross-section view of the flexible cable before being inserted into the electric connector in one embodiment of the present invention.

FIG. 5 illustrates a cross-sectional view of the flexible cable being inserted into the electric connector in one embodiment of the present invention.

FIG. 6 illustrates an exploded perspective view of the flexible cable after being inserted into the electric connector in one embodiment of the present invention.

### BRIEF DESCRIPTION OF THE DRAWINGS

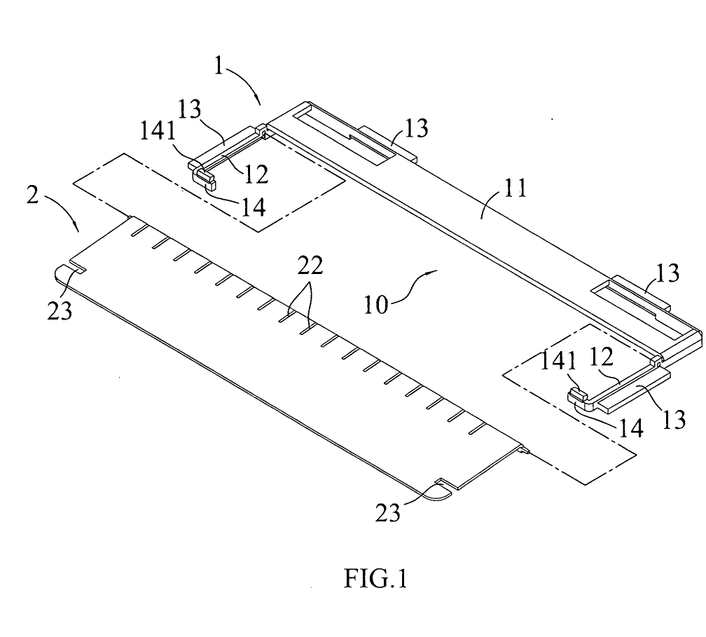

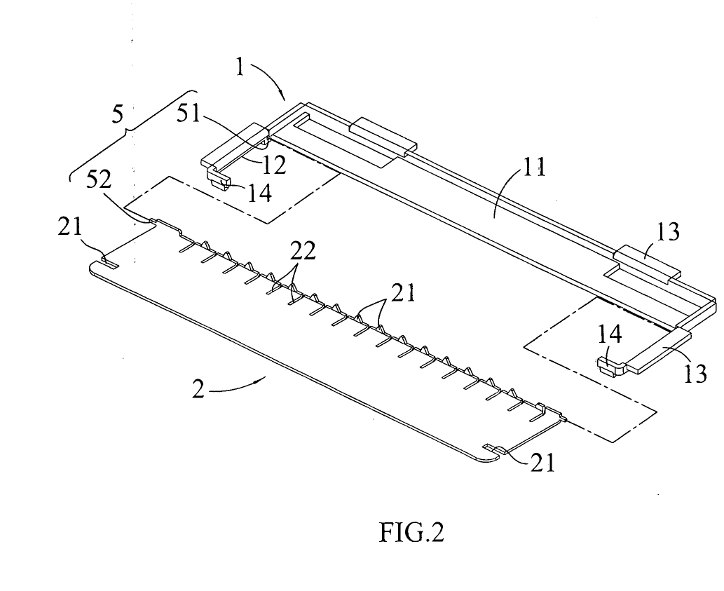

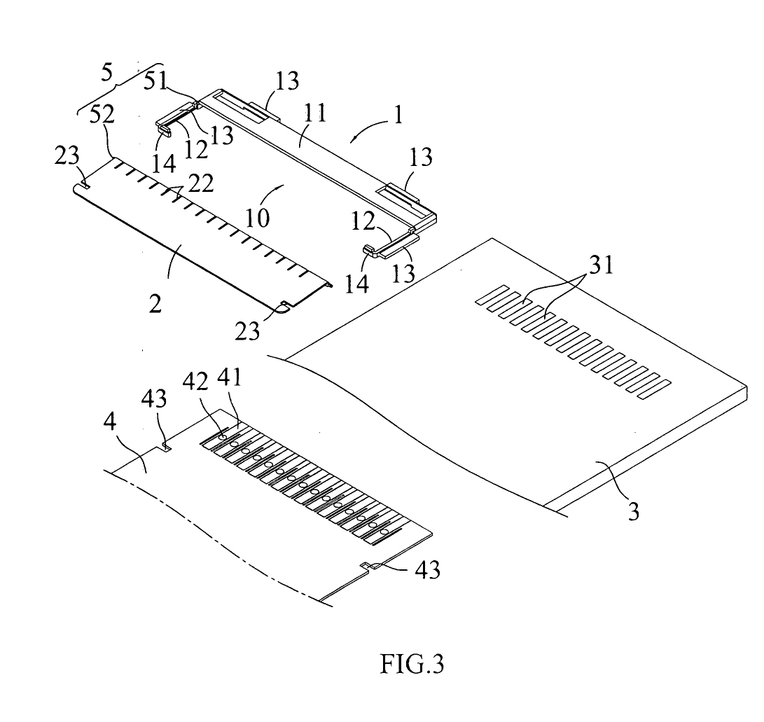

Please referring to FIG. 1, FIG. 2 and FIG. 3, FIG. 1 illustrates an exploded view of the electric connector in one embodiment of the present invention, and FIG. 2 illustrates another exploded view of the electric connector in one embodiment of the present invention, and FIG. 3 illustrates an exploded view of the electric connector and the module in one embodiment of the present invention. As shown in FIG. 1, FIG. 2 and FIG. 3, the electric connector of the present invention comprises a positioning housing 1 and a pressing member 2, and the module of the electric connector further comprises a circuit board 3 and a flexible flat cable 4. The structure, innovative features and performance of the present invention are described as following, and to make it clear, we define the direction that the flexible flat cable inserted to be the front.

In one embodiment, the material of the positioning housing 1 is preferably metal. The positioning housing 1 has a rectangular body 11 and lateral positioning arms 12 which are located on each side of the body 11 stretched forward from the body 11. The body 11 and the positioning arms 12 define a positioning space 10 therebetween for accommodating the flexible flat cable 4. The fixed parts 13 are located on the backend of the body 11 and the outer sides of the positioning arms 12 respectively, for soldering to the circuit board 3. The blockage parts 14 are located on the positioning arms 12 and protrude towards the positioning space 10 and opposed to each other. The blockage parts 14 has a bump 141 stretching up and curving towards the positioning space 10.

In one embodiment, the material of the pressing member 2 is preferably metal, and the pressing member 2 is a thin plate. The pinch points 21 are processed by integral molding and located at the button of the pressing member 2 evenly. The separate grooves 22 are located at the button of the pressing member 2 evenly, and each one of the separate grooves 22 is arranged between adjacent pinch points 21. The separate groove 22 can enhance the resilient pressing ability of the pinch point 21. Besides, the blockade grooves 23 are arranged on the pressing member 2 and their locations are corresponding to the blockage parts 14.

While assembling the electric connector, a rotating device 5 is applied for connecting the positioning housing 1 and the pressing member 2. The rotating device 5 has holes 51 located on each side of the positioning housing 1 and rotary shafts 52 located on each side of the pressing member 2. The rotary shafts 52 are embedded into the holes 51 of the positioning housing 1 such that the pressing member 2 is able to rotate relatively to the positioning housing 1 in a predetermined range. Therefore, the pressing member 2 can form an open status or the closed status of the positioning housing 1. Besides, the structure of the rotating device 5 is not limited to the embodiment mentioned above. The rotating device 5 can also has holes 51 located on each side of the pressing member 2 and rotary shafts 52 located on each side of the positioning housing 1. In other words, any device which can make the pressing member 2 rotate on the positioning housing 1, is not departing from the scope and spirit of rotating device 5 of the present invention which fall within the scope of the appended claims.

The circuit board 3 is a print circuit board with electric wires on it. The board terminal points 31 are mounted on the circuit board 3 for electrically connected to the flexible flat cable 4.

The flexible flat cable 4 is formed by using an upper insulated layer and a lower insulated layer to cover several conducting wires. A plurality of wire terminal points 41 are naked in each terminal of the flexible flat cable 4. In FIG. 3, we only show out the wire terminal points 41, i.e. the naked parts of the conducting wires, which is located at the front terminal of the flexible flat cable 4. The recessed part 42 is formed at the opposite side of the wire terminal points 41 for enhancing the coupling accuracy when the pinch points 21 press the flexible flat cable 4. Besides, the recessed grooves 43 are located on each side of the flexible flat cable 4 respectively.

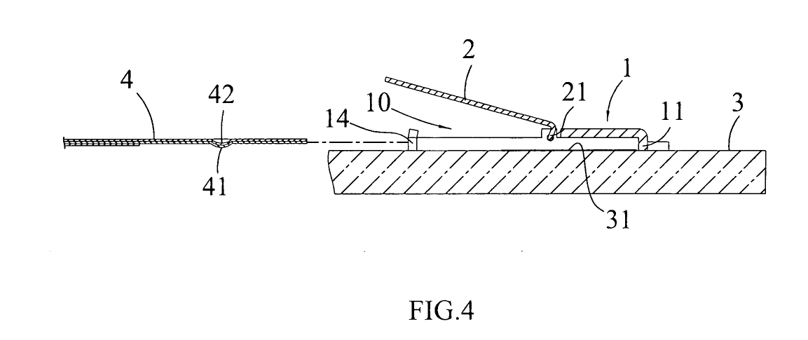

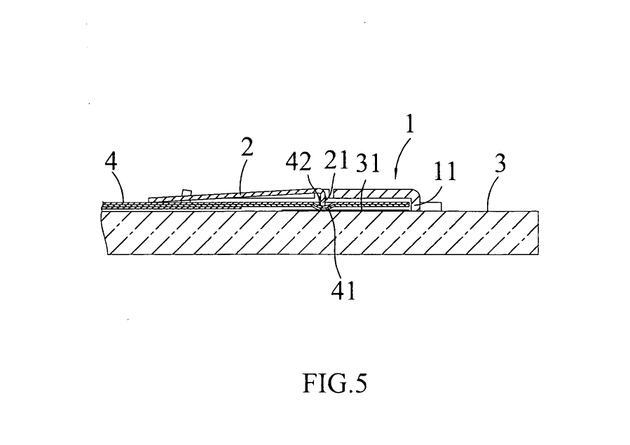

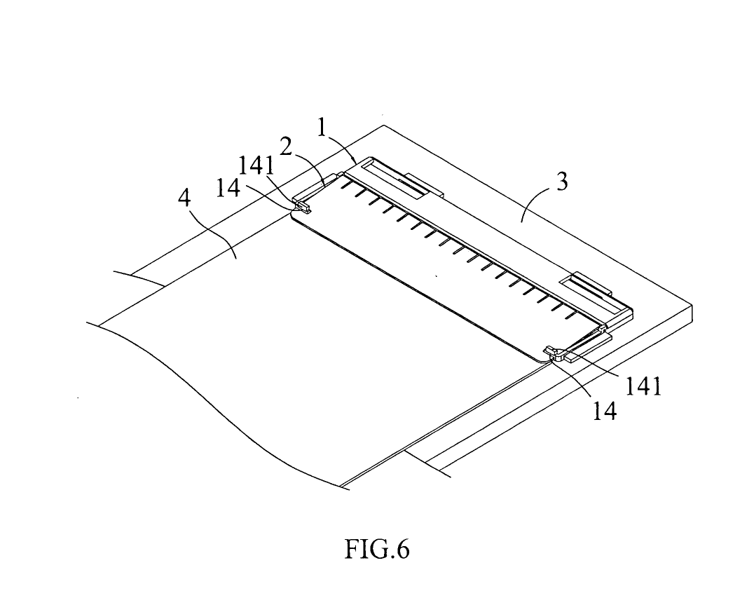

Please referring to FIG. 4, FIG. 5 and FIG. 6, FIG. 4 illustrates a cross-section view of the flexible cable before being inserted into the electric connector in one embodiment of the present invention, and FIG. 5 illustrates a cross-sectional view of the flexible cable being inserted into the electric connector in one embodiment of the present invention, and FIG. 6 illustrates an exploded perspective view of the flexible cable after being inserted into the electric connector in one embodiment of the present invention.

As shown in FIG. 4, FIG. 5 and FIG. 6, the pressing member 2 is rotated and opened first before inserting the flexible flat cable 4 into the electric connector. The flexible flat cable 4 is inserted to the positioning space 10 via the front end of the electric connector, and positioned when the front end of the flexible flat cable 4 contacts with the inner wall of the body 11. And the pressing member 2 is then rotated to a closed position. Meanwhile, the blockage parts 14 are embedded with the blockade grooves 23 located on the pressing member 2 for making the pressing member 2 press the flexible flat cable 4. Since the blockage parts 14 has the bumps 141, the blockade grooves 23 can contact with the bumps 141 and be blocked at the bottom of the bumps 141 for forming a stable closed status. At the same time, the pinch points 41 on the pressing member 2 press the recessed part 42 on the flexible flat cable 4 for making the wire terminal points 41 tightly contact with the board terminal points 31. Besides, the blockage parts 14 of the positioning housing 1 is able to be embedded with the recessed grooves 43 under the blockade grooves 23 for preventing the flexible flat cable 4 from being slipped out after the flexible flat cable 4 is inserted into the positioning space 10. And therefore, the wire terminal points 41 of the flexible flat cable 4 can tightly contact with the board terminal points 31 of the circuit board 3 for forming a stable electric connection.

Besides, in another embodiment, the structure of the pressing member can be an embolism form or an embedding form. And the structures mentioned above make the pressing member disable to rotate. While assembly, the flexible flat cable is inserted and positioned first, and the pressing member is fixed directly on the positioning housing so that the pinch points of the pressing member can press the surface of the flexible flat cable directly to fasten the flexible flat cable tightly.

In another embodiment, the positioning housing and the pressing member can be made by integral molding, so that the pinch points of the pressing member can tightly press the surface of the flexible flat cable after the flexible flat cable is inserted and positioned.

As mentioned above, the characteristic of the present invention is applying the positioning housing and the pressing member to form an electric connector, and further using the flexible flat cable and the circuit board to form a module, and making the flexible flat cable electrically connect to the circuit board via the electric connector without using the block terminals disclosed in the prior arts. And since the electric connector of the present invention has no block terminals, the structure of the electric connector module is flatter and simpler, and the assembly process is much simpler than the prior art implementations. Besides, pressing the pinch points of the pressing member directly onto the recessed part of the flexible flat cable to fix the flexible flat cable on the circuit board, and engaging the blockade part of the positioning arm with the recessed groove of the flexible flat cable, can make the electrical transmission smooth and stable.

While the present invention has been described by way of example and in terms of a preferred embodiment, it is to be understood that the present invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electric connector module comprising:
a positioning housing, mounted on a circuit board, having a body and lateral positioning arms located on each side of said body, and said body and said lateral positioning arms defining a positioning space for accommodating a flexible flat cable; and
a pressing member, rotatably mounted between said lateral positioning arms by a rotating device, and said pressing member having a plurality of pinch points arranged evenly and protruded towards said positioning space.

2. The electric connector module of claim 1, wherein said lateral positioning arms have blockage parts protruded towards said positioning space and opposed to each other.

3. The electric connector module of claim 2, wherein said pressing member has blockade groove arranged thereon, and said blockage part is engaged with said blockade groove when said pressing member is placed in closed position.

4. The electric connector module of claim 1, wherein said rotating device comprises holes located on said positioning housing and rotary shafts located on each side of said pressing member, and said rotary shafts are embedded into said holes such that said pressing member can rotate in a predetermined range relative to said positioning housing.

5. The electric connector module of claim 1, wherein said electric connector module further comprises a flexible cable having a plurality of wire terminal points which face downwardly and are located in one end of said flexible cable, and said end of said flexible cable is inserted into said positioning space such that said pinch points are pressed onto said wire terminal points.

6. The electric connector module of claim 1, wherein a separate groove is disposed between any adjacent pinch points.

7. An electric connector module comprising:
a circuit board, having a plurality of board terminal points;
a positioning housing, mounted on said circuit board, and said positioning housing having a body and lateral positioning arms located on each side of said body, and said body and said lateral positioning arms defining a positioning space for accommodating said board terminal points;
a pressing member, rotatably mounted between said lateral positioning arms by a rotating device, having a plurality of pinch points arranged thereon and corresponding to said board terminal points; and
a flexible cable with one end inserted in said positioning space for making a plurality of wire terminal points of said flexible cable tightly contact with said board terminal points;
wherein, said pinch points are pressed onto said flexible cable for making said wire terminal points tightly contact with said board terminal points when said pressing member is placed in a closed position, so as to prevent said flexible cable from being slipped out.

8. The electric connector module of claim 7, wherein said lateral positioning arms have blockage parts located thereon and protruded towards said positioning space, and recessed grooves are located on each side of said flexible cable, and said blockage parts are embedded with said recessed grooves for preventing said flexible cable from being slipped out when said one end of said flexible cable is inserted into said positioning space.

9. The electric connector module of claim 8, wherein said pressing member has blockade grooves arranged thereon for engaging with said blockage parts when said pressing member is placed in closed position.

10. The electric connector module of claim 7, wherein the opposite surface of said wire terminal points of said flexible cable has a recessed part, and when said pressing member is rotated to a closed position, said pinch points are pressed onto said recessed part so as to increase the coupling accuracy and prevent said pressing member from being slipped from said closed position.
